(19) United States
(12) Patent Application Publication
(10) Pub. No.: US 2023/0208615 A1
(43) Pub. Date: Jun. 29, 2023

(54) Online-Streamer Image Model File Transmission in Co-Hosting During Livestreaming

(71) Applicant: Shanghai Bilibili Technology Co., Ltd., Shanghai (CN)

(72) Inventors: Wei ZHANG, Shanghai (CN); Jiangtao HU, Shanghai (CN)

(21) Appl. No.: 18/073,330

(22) Filed: Dec. 1, 2022

(30) Foreign Application Priority Data
Dec. 27, 2021 (CN) 202111614133.4

(51) Int. Cl. H04L 9/06; H04N 21/2187; H04N 21/2347

(52) U.S. Cl. CPC H04L 9/065; H04N 21/2187; H04N 21/2347

(57) ABSTRACT

This application provides an online-streamer image model file transmission method and computing device in co-hosting during livestreaming. The method includes: receiving an online-streamer image model file sent by a first online streamer end, and obtaining a target obfuscation key and a target encryption type; determining to-be-encrypted bytes in the online-streamer image model file based on the target encryption type, and encrypting the to-be-encrypted bytes based on the target obfuscation key to obtain an encrypted online-streamer image file; and receiving an interaction request between the first online streamer end and a second online streamer end, and sending the encrypted online-streamer image file to the second online streamer end based on the interaction request.

### CROSS-REFERENCE TO RELATED APPLICATION

The present application claims priority to Chinese Patent Application No. 202111614133.4, filed with the China National Intellectual Property Administration on Dec. 27, 2021, which is incorporated herein by reference in its entirety.

### TECHNICAL FIELD

This application relates to the field of computer technologies, and in particular, to an online-streamer image model file transmission method in co-hosting during livestreaming. This application also relates to a computing device and a computer-readable storage medium.

### BACKGROUND

With continuous development of computer technologies, livestreaming on a network social platform gradually becomes a popular form of real-time interaction. In the livestreaming field, more online streamers choose to perform livestreaming by using avatars, and livestreaming performed by online streamers by using avatars becomes a new content form in the livestreaming industry. In the livestreaming process, using avatars for interaction between online streamers produces beneficial and positive effects on livestreamed content, user attention to the online streamers, and the like.

### SUMMARY

Embodiments of this application provide an online-streamer image model file transmission method in co-hosting during livestreaming. This application also relates to an online-streamer image model file transmission apparatus in co-hosting during livestreaming, a computing device, and a computer-readable storage medium.

According to a first aspect of the embodiments of this application, a method is provided, where the method is applied to a server and includes:

receiving an online-streamer image model file sent by a first online streamer end, and obtaining a target obfuscation key and a target encryption type;

determining to-be-encrypted bytes in the online-streamer image model file based on the target encryption type, and encrypting the to-be-encrypted bytes based on the target obfuscation key to obtain an encrypted online-streamer image file; and

receiving an interaction request between the first online streamer end and a second online streamer end, and sending the encrypted online-streamer image file to the second online streamer end based on the interaction request.

According to a second aspect of the embodiments of this application, a method is provided, where the method is applied to a target client and includes:

receiving an encrypted online-streamer image file and a target obfuscation key sent by a server;

determining a target encryption type of the encrypted online-streamer image file based on the encrypted online-streamer image file; and

decrypting the encrypted online-streamer image file based on the target obfuscation key and the target encryption type to obtain an online-streamer image model file.

According to a third aspect of the embodiments of this application, a computing device is provided. The computing device is applied to a second online streamer end and includes: one or more processors, and a memory storing one or more programs configured to be executed by the one or more processors, the one or more programs including instructions for: receiving an encrypted online-streamer image file and a target obfuscation key sent by a server; determining a target encryption type of the encrypted online-streamer image file based on the encrypted online-streamer image file; and decrypting the encrypted online-streamer image file based on the target obfuscation key and the target encryption type to obtain an online-streamer image model file.

According to a fourth aspect of the embodiments of this application, a computing device is provided, including one or more processors; a memory storing one or more programs configured to be executed by the one or more processors, the one or more programs including instructions for implementing the steps of the above method.

According to a fifth aspect of the embodiments of this application, a non-transient computer-readable storage medium storing one or more programs is provided. The one or more programs includes instructions, which when executed by one or more processors of an electronic device, cause the electronic device to implement the steps of the above method.

### BRIEF DESCRIPTION OF DRAWINGS

FIG. 1 is a flowchart of an online-streamer image model file transmission method applied to a server according to an embodiment of this application;

FIG. 2 is a schematic diagram of a file structure of an encrypted online-streamer image file according to an embodiment of this application;

FIG. 3 is a schematic diagram of a file structure of another encrypted online-streamer image file according to an embodiment of this application;

FIG. 4 is a flowchart of an online-streamer image model file transmission method applied to a second online streamer end according to an embodiment of this application;

FIG. 5 is a processing flowchart of an online-streamer image model file transmission method applied to co-hosting during livestreaming according to an embodiment of this application;

FIG. 6 is a schematic diagram of a structure of an online-streamer image model file transmission apparatus according to an embodiment of this application;

FIG. 7 is a schematic diagram of a structure of another online-streamer image model file transmission apparatus according to an embodiment of this application; and

FIG. 8 is a block diagram of a structure of a computing device according to an embodiment of this application.

### DESCRIPTION OF EMBODIMENTS

Many specific details are described in the following descriptions to facilitate full understanding of this application. However, this application can be implemented in many different manners from those described herein. A person skilled in the art may make similar promotion without departing from the connotation of this application. Therefore, this application is not limited to the specific implementations disclosed below.

Terms used in one or more embodiments of this application are merely used to describe specific embodiments, but are not intended to limit the one or more embodiments of this application. The terms “a” and “the” of singular forms used in one or more embodiments and the appended claims of this application are also intended to include plural forms, unless otherwise specified in the context clearly. It should be further understood that the term “and/or” used in one or more embodiments of this application indicates and includes any or all possible combinations of one or more associated listed items.

It should be understood that although terms such as “first” and “second” can be used in one or more embodiments of this application to describe various types of information, the information is not limited to these terms. These terms are only used to differentiate between information of the same type. For example, without departing from the scope of one or more embodiments of this application, “first” may also be referred to as “second”, and similarly, “second” may also be referred to as “first”. Depending on the context, for example, the word “if” used herein can be explained as “while”, “when”, or “in response to determining”.

Terms related to one or more embodiments of this application are first explained.

Elliptic-curve Diffie-Hellman (ECDH): is a key exchange protocol used to establish secure common encryption data in an insecure channel.

Symmetric encryption: is an encryption method using a single-key cryptosystem. A same key can be used to encrypt and decrypt information.

Advanced encryption standard (AES): is an advanced encryption standard in cryptography, and is a symmetric encryption algorithm.

Advanced Encryption Standard-Galois/Counter Mode (AES-GCM): GCM is one of authentication and encryption modes of AES, has features of GMAC and CTR, ensures confidentiality, integrity, and authenticity of data, and provides integrity check of an additional message.

Intellectual property (IP) image: An Internet IP image refers to the intellectual property image, including copyright, patent, and trademark.

Then, an online-streamer image model file transmission method in co-hosting during livestreaming provided in this application is described.

Currently, a virtual online streamer is a novel content form in fiercely competitive livestreaming formats. During livestreaming, interaction between multiple online streamers has a positive effect of 1+1>2 on content, and has a strong boost on a content ecology, revenue-generating capability of the online streamer, and the like.

In virtual services, interaction manners, such as co-hosting and PK, between friends or with a virtual group (or a guild) are favored by online streamers. However, currently, there are problems such as privacy of avatars (most of the avatars need to be downloaded), difficulty in technology implementation, and costs, and the foregoing interaction manners are in the hands of the guild. Consequently, a co-hosting ability cannot be well empowered to more online streamers. After online streamers are successfully connected to each other for interaction, avatar resources of the interaction parties need to be downloaded, in other words, a plurality of online streamers need to exchange respective avatars with each other, which is risky. That is, the largest disadvantage of localizing the avatar is that the security of the avatar of the online streamer is low, and the avatar is susceptible to leakage and is likely to be stolen by other users, impairing rights and interests of the online streamer.

Specifically, in terms of technology, interaction between online streamers mainly adopts an avatar localization solution: After an interaction connection succeeds, the online streamer downloads information of an interaction object such as an avatar resource and facial capture. Data is synchronized through a signaling transmission link. This can reduce traffic of video push, ensure definition, and have strong later expansibility and good compatibility. However, in the foregoing method, an IP image of the online streamer is easily disclosed, which results in misappropriation by an unauthorized user and damages rights and interests of the owner of the IP image.

Therefore, this application provides the online-streamer image model file transmission method in co-hosting during livestreaming, including: receiving an online-streamer image model file sent by a first online streamer end, and obtaining a target obfuscation key and a target encryption type; determining a to-be-encrypted byte in the online-streamer image model file based on the target encryption type, and encrypting the to-be-encrypted byte based on the target obfuscation key to obtain an encrypted online-streamer image file; and receiving an interaction request between the first online streamer end and a second online streamer end, and sending the encrypted online-streamer image file to the second online streamer end based on the interaction request.

The online-streamer image model file is encrypted based on the target obfuscation key and the target encryption type, so that image model information in a transmission process is in an encrypted state. This reduces a misappropriation risk of the image model information, and improves transmission security of the online-streamer image model file. By using a dynamically transformed encryption algorithm and encryption policy, different encryption algorithms, encryption policies, encryption ranges, and encryption keys are used for files. This minimizes losses of a compromised online-streamer image model file storage system. In addition, the method provided in this application is simple to apply, and reduces costs of transforming each client.

This application provides the online-streamer image model file transmission method. This application also relates to an online-streamer image model file transmitting apparatus, a computing device, and a computer-readable storage medium. Details are described in the following embodiments one by one.

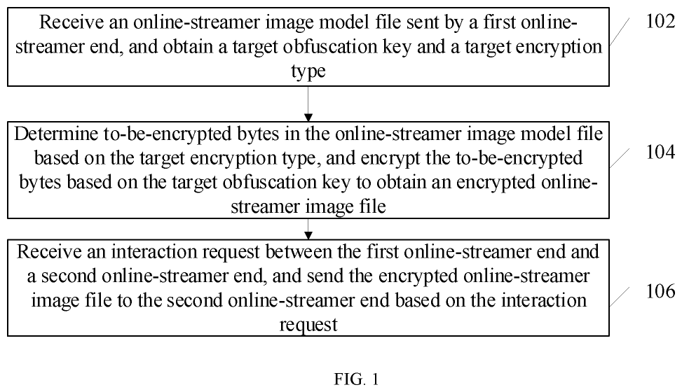

FIG. 1 is a flowchart of an online-streamer image model file transmission method applied to a server according to an embodiment of this application. The method specifically includes the following steps:

Step 102: Receive an online-streamer image model file sent by a first online streamer end, and obtain a target obfuscation key and a target encryption type.

Specifically, the first online streamer end refers to a client on which the first online streamer is located, and may be any intelligent device, for example, a mobile phone, a tablet computer, or an intelligent computer. An online streamer, that is, a network host, is a person, in an Internet program or activity, who is responsible for and participates in a series of work such as planning, editing, recording, production, and audience interaction and who is responsible for hosting. The first online streamer is any online streamer, and in some embodiments, the first online streamer is any online streamer that performs livestreaming with an avatar or an unreal character image. The online-streamer image model file is a file that includes attribute information required when an online-streamer avatar corresponding to the online streamer is generated. For example, the online-streamer image model file includes location information of an avatar A in a livestreaming scenario and action information of the avatar A. A key refers to a parameter entered in an algorithm for converting a plaintext into a ciphertext or converting a ciphertext into a plaintext. The target obfuscation key is a key for encrypting the online-streamer image model file of the first online streamer, where obfuscation refers to an encryption operation, for example, an operation of encrypting the online-streamer image model file by using an exclusive OR operation as an encryption operation.

In actual application, the first online streamer end in which the first online streamer is located generates the online-streamer image model file, and sends the online-streamer image model file to the server. The online-streamer image model file corresponding to the first online streamer end is stored in an online-streamer image model file list. A to-be-encrypted online-streamer image model file may be determined in the online-streamer image model file list based on an actual service requirement. After the to-be-encrypted online-streamer image model file is determined, a preset encryption algorithm is determined, and the target obfuscation key used to encrypt the online-streamer image model file is determined based on the encryption algorithm.

Specifically, in the method, obtaining the target obfuscation key includes:

determining a target encryption algorithm; and

generating the target obfuscation key based on the target encryption algorithm.

The target encryption algorithm is an algorithm for encrypting the online-streamer image model file, for example, an AES, a DES, or another encryption algorithm. The target obfuscation key is a key randomly determined based on the target encryption algorithm.

In actual application, to improve security of the online-streamer image model file in transmission, online-streamer image model files may be encrypted by using different encryption algorithms. That is, after the to-be-encrypted online-streamer image model file is determined, the target encryption algorithm may be determined based on algorithm information preconfigured by a system, or an encryption algorithm is randomly determined for the to-be-encrypted online-streamer image model file based on a preset algorithm selection rule as the target encryption algorithm for encrypting the online-streamer image model file.

In a specific implementation of this application, for example, the target encryption algorithm is determined based on the algorithm information preconfigured by the system. A to-be-encrypted online-streamer image model file A is determined based on a service requirement. The algorithm information (an AES-GCM algorithm) preconfigured by the system is obtained. The AES-GCM algorithm refers to a GCM encryption model in an AES algorithm. The AES-GCM algorithm is used as a target encryption algorithm for encrypting the online-streamer image model file A.

In another specific implementation of this application, for example, the encryption algorithm is randomly determined based on the preset algorithm selection rule for the to-be-encrypted online-streamer image model file. A to-be-encrypted online-streamer image model file B is determined based on a service requirement, and a preset algorithm selection rule is obtained. The preset algorithm selection rule includes an encryption algorithm list of encryption algorithms that can encrypt the online-streamer image model file. The encryption algorithm list includes an AES algorithm, a DES algorithm, and the like. If the DES algorithm is randomly selected from the encryption algorithm list based on the preset algorithm selection rule, the DES algorithm is used as an encryption algorithm for encrypting the online-streamer image model file.

The encryption algorithm of the to-be-encrypted online-streamer image model file is randomly determined. This helps determine corresponding obfuscation keys based on different encryption algorithms, and subsequently encrypt the online-streamer image model files based on the different encryption algorithms, thereby improving transmission security of the online-streamer image model file.

After the target encryption algorithm is determined, the target obfuscation key may be randomly generated based on the target encryption algorithm. For example, if the AES encryption algorithm is determined, where a key length that may be supported by the AES encryption algorithm is 128 bits, a key of a corresponding bit quantity is randomly generated based on the AES algorithm as the target obfuscation key.

After the encryption algorithm for encrypting the online-streamer image model file and the corresponding target obfuscation key are determined, a file encryption policy, that is, the target encryption type, for encrypting the online-streamer image model file needs to be further determined.

Specifically, in the method, obtaining the target encryption type includes:

obtaining a preset selection rule; and

determining the target encryption type based on the preset selection rule.

The preset selection rule is a rule of selecting a file encryption policy of the to-be-encrypted online-streamer image model file. The target encryption type refers to a target file encryption policy used when the online-streamer image model file is encrypted. For example, the online-streamer image model file A is encrypted by using a full encryption policy, that is, all bytes included in the online-streamer image model file A are encrypted.

In actual application, to further enhance transmission security of the online-streamer image model file, in addition to using the different encryption algorithms for the online-streamer image model files, encryption may be performed on online-streamer image model files by using different file encryption types. That is, after the to-be-encrypted online-streamer image model file is determined, a target encryption type may be determined based on encryption type information preconfigured by the system, or an encryption type is randomly selected for the to-be-encrypted online-streamer image model file based on a preset selection rule as the target encryption type when the to-be-encrypted online-streamer image model file is encrypted.

In a specific implementation of this application, for example, the target encryption type is randomly selected for the to-be-encrypted online-streamer image model file based on the preset selection rule. The to-be-encrypted online-streamer image model file B is determined. The preset selection rule is obtained, where the preset selection rule includes a file encryption type list. If a full encryption type is randomly selected from the file encryption type list, the full encryption type is used as a target encryption type for encrypting the online-streamer image model file B.

It should be noted that, in addition to encrypting the attribute information in the online-streamer image model file, an online-streamer image picture in the online-streamer image model file may be encrypted. Specifically, a picture encryption method corresponding to the online-streamer image picture may be used to encrypt and transmit the online-streamer image picture. In this way, a virtual online-streamer image file is protected in multiple aspects, and a transmission risk of the online-streamer image model file is reduced.

In this application, the different encryption algorithms, different obfuscation keys, and different encryption types are determined for different online-streamer image model files. This helps subsequently encrypt different online-streamer image model files based on different encryption algorithms, different obfuscation keys, and different encryption types, and further minimize subsequent loss of a compromised online-streamer image model file.

Step 104: Determine a to-be-encrypted byte in the online-streamer image model file based on the target encryption type, and encrypt the to-be-encrypted byte based on the target obfuscation key to obtain an encrypted online-streamer image file.

Specifically, after the target obfuscation key and the target encryption type used to encrypt the to-be-encrypted online-streamer image model file are determined, the online-streamer image model file may be encrypted based on the target obfuscation key and the target encryption type, so as to obtain the encrypted encrypted online-streamer image file.

In actual application, to meet an actual service requirement and improve encryption efficiency, before encryption processing is performed on the online-streamer image model file based on the target obfuscation key and the target encryption type, the method further includes:

receiving an online-streamer image model file encryption request, where the online-streamer image model file encryption request includes service requirement information; and

in response to the online-streamer image model file encryption request, traversing a model file list corresponding to the first online streamer end, and determining an online-streamer image model file that meets the service requirement information and that is in the model file list.

The online-streamer image model file encryption request is a request for encrypting the to-be-encrypted online-streamer image model file. The model file list is a list of at least one online-streamer image model file corresponding to the first online streamer.

Specifically, each online-streamer end has a corresponding model file list, and each model file list includes multiple online-streamer image model files. To improve transmission efficiency of the online-streamer image model file, the to-be-encrypted online-streamer image model file may be determined based on the service requirement information in the encryption request, to perform encryption.

In a specific implementation of this application, the online-streamer image model file A is used as an example. After receiving an online-streamer image model file encryption request, the server traverses a model file list corresponding to an online-streamer end in response to the encryption request, and determines, based on location requirement information carried in the encryption request, the online-streamer image model file A that carries location information and that is in the model file list as a to-be-encrypted online-streamer image model file.

Based on the service requirement information in the encryption request, the to-be-encrypted online-streamer image model file is determined in the model file list, that is, only the determined online-streamer image model file is subsequently encrypted. This improves encryption efficiency of encrypting the online-streamer image model file.

After the to-be-encrypted online-streamer image model file and the target obfuscation key and the target encryption type of the online-streamer image model file are determined, the online-streamer image model file is encrypted based on the target obfuscation key and the target encryption type.

In actual application, in the method, performing encryption processing on the online-streamer image model file based on the target obfuscation key and the target encryption type to obtain the encrypted online-streamer image file may include S104-102 to S104-108.

S104-102. If the target encryption type is a prefix encryption type, determine ciphertext length information based on file attribute information of the online-streamer image model file.

The prefix encryption type refers to an encryption policy for encrypting some bytes in the online-streamer image model file. The file attribute information refers to a size of the online-streamer image model file. For example, attribute information of the online-streamer image model file A is a file size 3k. The ciphertext length information is a length of the to-be-encrypted byte in the online-streamer image model file.

Specifically, for example, the size of the online-streamer image model file is 10 bytes. When N power of 2 is greater than 10, a value of N is used as the ciphertext length information, for example, the ciphertext length information is 4 bytes.

S104-104. Determine the to-be-encrypted byte and a plaintext byte in the online-streamer image model file based on the ciphertext length information.

The to-be-encrypted byte is a byte that needs to be encrypted in the online-streamer image model file. The plaintext byte is a byte that does not need to be encrypted in the online-streamer image model file.

Specifically, in the above example, 4 bytes are determined, based on the ciphertext length information 4 bytes, in the online-streamer image model file as to-be-encrypted bytes to be subsequently encrypted, and the remaining 6 bytes are plaintext bytes.

S104-106. Encrypt the to-be-encrypted byte based on the target obfuscation key to obtain an encrypted ciphertext.

The encrypted ciphertext refers to an encryption byte obtained by encrypting the to-be-encrypted byte based on the obfuscation key.

Specifically, in the above example, the four to-be-encrypted bytes are encrypted based on the target obfuscation key to obtain 4 bytes of encrypted ciphertexts.

S104-108. Generate the encrypted online-streamer image file based on the encrypted ciphertext, the plaintext byte, and the ciphertext length information.

The encrypted online-streamer image file is a file obtained by encrypting the online-streamer image model file.

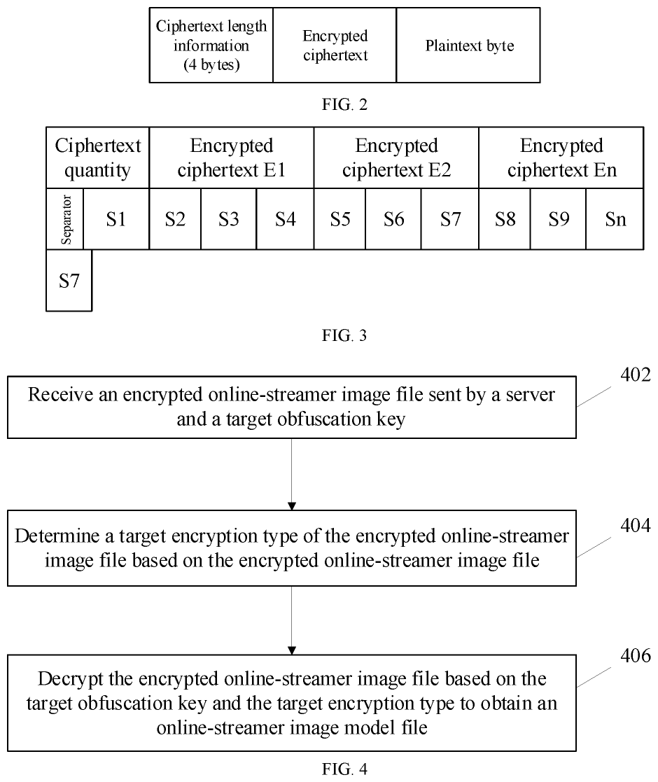

Specifically, in the above example, the ciphertext length information, the encrypted ciphertext, and the plaintext byte are encapsulated as the encrypted online-streamer image file. A file structure of the encrypted encrypted online-streamer image file is shown in FIG. 2. FIG. 2 is a schematic diagram of a file structure of an encrypted online-streamer image file according to an embodiment of this application.

Encryption processing is performed on the online-streamer image model file based on the prefix encryption type and the target obfuscation key, that is, the online-streamer image model file is encrypted by using a random encryption algorithm and the file encryption policy. This improves transmission security of the online-streamer image model file.

In actual application, in the method, performing encryption processing on the online-streamer image model file based on the target obfuscation key and the target encryption type to obtain the encrypted online-streamer image file may include S104-202 to S104-206.

S104-202. If the target encryption type is a segmented encryption type, determine at least two byte segments in the online-streamer image model file according to a preset segmentation rule, where each byte segment includes a to-be-encrypted byte and a plaintext byte.

The segmented encryption type refers to an encryption policy for encrypting a byte segment in an online-streamer image model. The preset segmentation rule is a rule for segmenting at least two byte segments in the online-streamer image model file. Specifically, the rule may be that M bytes are selected every N bytes for encryption, where M and N are positive integers and are not equal to 0. If there are remaining Q bytes and Q is less than M, the remaining Q bytes may form one byte segment. The byte segment refers to a byte segment formed by some bytes in the online-streamer image model file. For example, five consecutive bytes are determined, first 3 bytes are to-be-encrypted bytes, and last two bytes are plaintext bytes, so that the 5 bytes forms one byte segment.

Specifically, the online-streamer image model file B is used as an example. It is determined that content of the preset segmentation rule is to select 2 bytes every 3 bytes. Therefore, the online-streamer image model file is segmented based on the preset segmentation rule to obtain multiple byte segments, where each byte segment includes three to-be-encrypted bytes and two plaintext bytes.

S104-204. Encrypt the to-be-encrypted byte in each byte segment based on the target obfuscation key to obtain an encrypted ciphertext, and count a ciphertext quantity of encrypted ciphertexts.

Each byte segment includes the to-be-encrypted byte, byte segments are cyclically read, and to-be-encrypted bytes in the byte segments are segmented to obtain the encrypted ciphertexts. When each byte segment includes an encrypted byte, the ciphertext quantity is a quantity of the byte segments in the online-streamer image model file.

Specifically, in the above example, the to-be-encrypted bytes in the byte segments are cyclically read. The to-be-encrypted byte in each byte segment is encrypted based on the target obfuscation key to obtain the encrypted ciphertext. Further, the ciphertext quantity of the encrypted ciphertexts is counted.

S104-206. Generate the encrypted online-streamer image file based on the encrypted ciphertext and the plaintext byte in each byte segment and the ciphertext quantity.

Specifically, in the above example, the encrypted ciphertext and the plaintext byte in each byte segment, a counted ciphertext quantity, and a separator are encapsulated as the encrypted online-streamer image file. Specifically, the encrypted ciphertext is stored in rows and the plaintext byte is continuously stored. The separator refers to a separation length determined based on a length of the encrypted ciphertext. A structure of the encrypted online-streamer image model file is shown in FIG. 3. FIG. 3 is a schematic diagram of a file structure of another encrypted online-streamer image file according to an embodiment of this application. In the figure, E1, . . . , and En are encrypted ciphertexts, and S1, . . . , and Sn are plaintext bytes.

Encryption processing is performed on the online-streamer image model file based on the segmented encryption type and the target obfuscation key, that is, the online-streamer image model file is encrypted by using a random encryption algorithm and the file encryption policy. This improves transmission security of the online-streamer image model file.

In actual application, in the method, performing encryption processing on the online-streamer image model file based on the target obfuscation key and the target encryption type to obtain the encrypted online-streamer image file may include S104-302 to S104-304.

S104-302. If the target encryption type is a full encryption type, use each byte in the online-streamer image model file as a to-be-encrypted byte, and encrypt the to-be-encrypted byte based on the target obfuscation key to obtain an encrypted ciphertext.

The full encryption type refers to an encryption policy for encrypting all bytes in the online-streamer image model file.

Specifically, an online-streamer image model file C is used as an example. A to-be-encrypted byte in the online-streamer image model file C is determined, and the to-be-encrypted byte is encrypted based on the target obfuscation key to obtain the encrypted ciphertext.

S104-304. Generate the encrypted online-streamer image file based on the encrypted ciphertext.

Specifically, in the above example, the encrypted ciphertext is encapsulated to obtain the encrypted online-streamer image file.

Encryption processing is performed on the online-streamer image model file based on the full encryption type and the target obfuscation key, that is, the online-streamer image model file is encrypted by using a random encryption algorithm and the file encryption policy. This improves transmission security of the online-streamer image model file.

In actual application, in addition to the foregoing file encryption type, the online-streamer image model file may be encrypted by using another file encryption type, which is not specifically limited in this application, provided that the file encryption type can be used to encrypt the to-be-encrypted online-streamer image model file.

After an encryption manner of the to-be-encrypted online-streamer image model file is determined, a mapping relationship between the encryption manner and the to-be-encrypted file is established, and serially stored into a database, so as to subsequently determine how to decrypt the online-streamer image model file. Specifically, the encryption manner includes an encryption type, an encryption algorithm, and an obfuscation key.

The online-streamer image model file is encrypted based on a randomly determined obfuscation key and a randomly determined encryption type, which helps improve subsequent transmission security of the online-streamer image model file.

Step 106: Receive an interaction request between the first online streamer end and a second online streamer end, and send the encrypted online-streamer image file to the second online streamer end based on the interaction request.

Specifically, the interaction request is a request generated based on an interaction requirement between two online streamers, and may be a co-hosting request, a pk request, or the like. The second online streamer end refers to a client on which a second online streamer is located, which may be any intelligent device, for example, a mobile phone, a tablet computer, or an intelligent computer, or refers to a client corresponding to an audience of the second online streamer. The second online streamer refers to an online streamer interacting with the first online streamer.

In actual application, after the server receives a request that is sent by the first online streamer end for interacting with the second online streamer end or receives a request that is sent by the second online streamer end for interacting with the first online streamer end, that is, after the server receives the interaction request for the first online streamer end and the second online streamer end, the server determines, based on an online-streamer identifier of the second online streamer in the interaction request, the second online streamer end corresponding to the second online streamer and an audience client corresponding to an audience of the second online streamer; and sends the encrypted online-streamer image file and the target obfuscation key to the second online streamer end. Then, the second online streamer end decrypts the encrypted online-streamer image file based on the target obfuscation key to obtain the online-streamer image model file of the first online streamer, and further renders and displays an avatar of the first online streamer on the second online streamer end based on the online-streamer image model file of the first online streamer.

It should be noted that, to ensure transmission security of the online-streamer image model file, the server sends the encrypted online-streamer image file and the target obfuscation key to the second online streamer end in two times. First, when receiving the interaction request for the first online streamer end and the second online streamer end, the server sends, based on the online-streamer identifier of the second online streamer in the interaction request, the encrypted online-streamer image file to the second online streamer end associated with the second online streamer. Then, after receiving the encrypted online-streamer image file, the second online streamer end requests the target obfuscation key from the server. In this case, the server sends the target obfuscation key to a target client. To improve transmission security of the key, a transmission connection that is used to transmit the key can be established based on a key transmission protocol (for example, an ECDH protocol). Before sending the target obfuscation key to the second online streamer end, the server further needs to record file usage information of the second online streamer end. The file usage information includes at least one of a user identifier, a usage scenario, a usage range, a usage file identifier, and a usage time that are corresponding to the second online streamer end. In this way, based on usage traceability of the target obfuscation key, a leakage path can be traced, so as to provide clues and data support for accountability and preservation after an unfortunate loss.

This application provides the online-streamer image model file transmission method in co-hosting during livestreaming, including: receiving an online-streamer image model file sent by a first online streamer end, and obtaining a target obfuscation key and a target encryption type; determining a to-be-encrypted byte in the online-streamer image model file based on the target encryption type, and encrypting the to-be-encrypted byte based on the target obfuscation key to obtain an encrypted online-streamer image file; and receiving an interaction request between the first online streamer end and a second online streamer end, and sending the encrypted online-streamer image file to the second online streamer end based on the interaction request. The online-streamer image model file is encrypted based on the target obfuscation key and the target encryption type. This ensures that the online-streamer image model file is not easily obtained, effectively reduces a leakage risk of the online-streamer image model file, and improves transmission security of the online-streamer image model file.

FIG. 4 is a flowchart of an online-streamer image model file transmission method applied to a second online streamer end according to an embodiment of this application. The method specifically includes the following steps:

Step 402: Receive an encrypted online-streamer image file and a target obfuscation key sent by a server.

Specifically, the second online streamer end refers to a client on which a second online streamer is located, which may be any intelligent device, for example, a mobile phone, a tablet computer, or an intelligent computer, or refers to a client corresponding to an audience of the second online streamer. The encrypted online-streamer image file is a file obtained by performing encryption processing on an online-streamer image model file. The target obfuscation key is a key for encrypting the online-streamer image model file, and may be a string, such as a combination of at least one of a number, a letter, and a symbol, or may be in a form of a matrix, an array, or the like.

In actual application, after receiving an online-streamer image model file of a first online streamer sent by a first online streamer end, the server obtains the target obfuscation key and a target encryption type, and then performs encryption processing on the image model file based on the target obfuscation key and the target encryption type to obtain the encrypted online-streamer image file. Then, after the server receives an interaction request between the first online streamer end and the second online streamer end, the server determines, based on an online-streamer identifier of the second online streamer in the interaction request, a second client corresponding to the second online streamer or the client corresponding to the audience of the second online streamer, that is, the second online streamer end, and sends the encrypted online-streamer image file and the target obfuscation key to the second online streamer end. That is, the second online streamer end receives the encrypted online-streamer image file and the target obfuscation key sent by the server.

Step 404: Determine the target encryption type of the encrypted online-streamer image file based on the encrypted online-streamer image file.

Specifically, after receiving the encrypted online-streamer image file, the server parses the encrypted online-streamer image file to determine an encryption type of the encrypted online-streamer image file. For example, if parsing the encrypted online-streamer image file and determining that the encrypted online-streamer image file does not include a plaintext byte, the server determines that the target encryption type corresponding to the encrypted online-streamer image file is a full encryption type.

Step 406: Decrypt the encrypted online-streamer image file based on the target obfuscation key and the target encryption type to obtain the online-streamer image model file.

In actual application, in the method, decrypting the encrypted online-streamer image file based on the target obfuscation key and the target encryption type to obtain the online-streamer image model file may include:

if the target encryption type is a prefix encryption type, obtaining ciphertext length information in the encrypted online-streamer image file;

determining an encrypted ciphertext and a plaintext byte in the encrypted online-streamer image file based on the ciphertext length information, and decrypting the encrypted ciphertext based on the target obfuscation key to obtain a to-be-encrypted byte; and

obtaining the online-streamer image model file based on the to-be-encrypted byte and the plaintext byte.

For example, if it is determined that a target encryption type of an encrypted online-streamer image file A is the prefix encryption type, 10-byte ciphertext length information of the encrypted online-streamer image file A is obtained. Based on the 10-byte ciphertext length information, a 10-byte encrypted ciphertext in the encrypted online-streamer image file A is determined. The encrypted ciphertext is decrypted based on the target obfuscation key to obtain decrypted bytes. The decrypted bytes are combined with a plaintext byte to obtain an online-streamer image model file.

In actual application, in the method, decrypting the encrypted online-streamer image file based on the target obfuscation key and the target encryption type to obtain the online-streamer image model file may include:

if the target encryption type is a segmented encryption type, obtaining a ciphertext quantity in the encrypted online-streamer image file;

determining a byte segment in the encrypted online-streamer image file based on the ciphertext quantity, and decrypting an encrypted ciphertext in each byte segment based on the target obfuscation key to obtain a to-be-encrypted byte and a plaintext byte; and

obtaining the online-streamer image model file based on the to-be-encrypted byte and the plaintext byte.

For example, if it is determined that a target encryption type of an encrypted online-streamer image file B is segmented encryption, a ciphertext quantity of the encrypted online-streamer image file B is obtained. A byte segment in the encrypted online-streamer image file B is determined based on the ciphertext quantity, and an encrypted ciphertext in each byte segment is decrypted based on the target obfuscation key to obtain a decrypted byte. A separator in the encrypted online-streamer image file B is determined, and the decrypted byte obtained in each byte segment is inserted into a corresponding separator area. In this way, the decrypted byte and the plaintext byte are encapsulated as the online-streamer image model file.

In actual application, in the method, decrypting the encrypted online-streamer image file based on the target obfuscation key and the target encryption type to obtain the online-streamer image model file may include:

if the target encryption type is a full encryption type, decrypting an encrypted ciphertext in the encrypted online-streamer image file based on the target obfuscation key to obtain a to-be-encrypted byte; and

obtaining the online-streamer image model file based on the to-be-encrypted byte.

For example, if it is determined that a target encryption type of an encrypted online-streamer image file C is full encryption, an encrypted ciphertext in the encrypted online-streamer image file C is decrypted based on the target obfuscation key to obtain a decrypted byte. The decrypted byte forms the online-streamer image model file.

This application provides the online-streamer image model file transmission method applied to the second online streamer end, including: receiving an encrypted online-streamer image file and a target obfuscation key sent by a server; determining a target encryption type of the encrypted online-streamer image file based on the encrypted online-streamer image file; and decrypting the encrypted online-streamer image file based on the target obfuscation key and the target encryption type to obtain an online-streamer image model file. The encrypted online-streamer image file obtained by encrypting the online-streamer image model file based on the target obfuscation key and the target encryption type is decrypted. This ensures that the online-streamer image model file is not easily obtained, effectively reduces a leakage risk of the online-streamer image model file, and improves transmission security of the online-streamer image model file.

In addition to the foregoing encryption and transmission of model attribute information in the online-streamer image model file, an online-streamer image picture in the online-streamer image model file needs to be encrypted and transmitted, so as to ensure security of the online-streamer image model file during transmission. The following embodiment describes an online-streamer image picture transmission method, applied to a server, including steps a1 to a3.

Step a1: Receive an online-streamer image picture sent by a first online streamer end, and obtain a target obfuscation key.

Specifically, an online streamer, that is, a network host, is a person, in an Internet program or activity, who is responsible for and participates in a series of work such as planning, editing, recording, production, and audience interaction and who is responsible for hosting. A first online streamer is any online streamer, and in some embodiments, the first online streamer is any online streamer that performs livestreaming with an avatar or an unreal character image. The first online streamer end refers to a client on which the first online streamer is located, which may be any type of intelligent device, for example, a mobile phone, a tablet computer, or an intelligent computer. The online-streamer image picture refers to a picture resource used when an online streamer avatar is formed, that is, a model texture mapping resource of the avatar. Obfuscation is an encryption operation that obfuscates a relationship between a key and a ciphertext (the online-streamer image picture) as much as possible. The target obfuscation key is a key corresponding to obfuscation, and may be a string, such as a combination of at least one of a number, a letter, and a symbol, or may be in a form of a matrix, an array, or the like.

In actual application, when an online streamer selects, on an upload screen of an online-streamer image picture by using a client on which the online streamer is located (that is, an online streamer end), an online-streamer image picture that needs to be uploaded by the online streamer and that is used to construct an avatar of the online streamer, after “OK” or any button that indicates confirmation of uploading is clicked, the online streamer end sends the online-streamer image picture to the server. That is, the first online streamer end sends the online-streamer image picture to the server. That is, the server receives the online-streamer image picture sent by the first online streamer end. Further, to ensure security when sending the online-streamer image picture to another online streamer, that is, another online streamer end, the server needs to encrypt the online-streamer image picture. Therefore, a key for encrypting the online-streamer image picture can be obtained first, that is, the target obfuscation key.

It should be noted that, the first online streamer may further send, to the server by using the first online streamer end, an online-streamer image model file that needs to be uploaded by the first online streamer for constructing an online streamer image. The image model file includes the online-streamer image picture and an online-streamer image model. The online-streamer image model may be two-dimensional or may be three-dimensional. This is not limited in this application. The server may first receive the online-streamer image model file sent by the first online streamer end, then, may obtain the online-streamer image picture from the online-streamer image model file, obtain the target obfuscation key, and record a correspondence between the target obfuscation key and the online-streamer image picture, that is, the target obfuscation key is uniquely corresponding to the online-streamer image picture.

To improve security of the target obfuscation key, the server may first obtain an initial obfuscation key, and then perform conversion on the initial obfuscation key to obtain the target obfuscation key, that is, obtain the target obfuscation key. A specific implementation process may be as follows:

obtaining the initial obfuscation key; and

performing preset bitwise operation processing on the initial obfuscation key to obtain the target obfuscation key.

Specifically, the initial obfuscation key is an obfuscation key that is directly obtained by the server without any processing. Bitwise operation processing refers to directly performing, on a binary bit number, an operation, for example, bitwise AND, bitwise OR, leftward shifting, or rightward shifting. The preset bitwise operation processing refers to performing preset bitwise operation processing on a binary bit corresponding to the initial obfuscation key.

In actual application, the server may first randomly generate an initial obfuscation key. The randomly generated initial obfuscation key may be obtained from a memory of the server, and data in a computer (the server or the online streamer end) all exists in a binary form. Therefore, to ensure security of the obfuscation key and increase difficulty of cracking, preset bitwise operation processing needs to be performed on the obtained initial obfuscation key, so as to obtain the target obfuscation key.

To further improve security of the target obfuscation key to further improve transmission security of the online-streamer image picture, randomization processing can be performed on each bit of the initial obfuscation key, that is, preset bitwise operation processing is performed on the initial obfuscation key to obtain the target obfuscation key. A specific implementation process may be as follows:

performing, by using a preset random algorithm for any bit of the initial obfuscation key, randomization processing on a value of the bit, to obtain a new value of the bit; and

generating the target obfuscation key based on the new value.

Specifically, when the initial obfuscation key is in a string form, any bit of the initial obfuscation key refers to any character in the string, or when the initial obfuscation key is a matrix or an array, any bit of the initial obfuscation key refers to any element in the matrix or the array. The random algorithm refers to that a random function is used in the algorithm, and a return value of the random function directly or indirectly affects an execution procedure or an execution result of the algorithm. The random algorithm is based on a random method and depends on a probability.

It should be noted that, after the initial obfuscation key is obtained, values of the first bit to the last bit of the initial obfuscation key may be recorded in an index table (key_array_index) in sequence. A first value is first taken out from the index table, and then randomization processing is performed on the value by using the preset random algorithm, to obtain a new value corresponding to the first bit of the initial obfuscation key. Then, a second value is first taken out from the index table, and then randomization processing is performed on the value by using the preset random algorithm, to obtain a new value corresponding to the second bit of the initial obfuscation key. By analogy, a new value corresponding to the last bit of the initial obfuscation key is obtained.

In some embodiments, randomization processing may be randomization processing for a bitwise operation.

Step a2: Perform encryption processing on the online-streamer image picture based on the target obfuscation key and picture information of the online-streamer image picture to obtain an online-streamer image encryption picture.

Specifically, the picture information, that is, picture data or image data, refers to a data set that represents a picture and includes a color value of a pixel, a quantity of pixels, a size of a picture, and the like. Encryption processing refers to a process of changing original information data by using a special algorithm, which may be an exclusive OR encryption algorithm, a shift encryption algorithm, an AND/OR algorithm, or the like.

In some embodiments, the picture information includes a color value of each pixel in the online-streamer image picture. Encryption processing may be performed on the color value of each pixel in the online-streamer image picture, to implement encryption processing on the online-streamer image picture. That is, based on the target obfuscation key and the picture information of the online-streamer image picture, encryption processing is performed on the online-streamer image picture to obtain the online-streamer image encryption picture. A specific implementation process may be as follows:

performing encryption processing on the color value of each pixel based on the target obfuscation key to obtain an encrypted color value of each pixel; and

generating the online-streamer image encryption picture based on each encrypted color value.

Specifically, a pixel is a most basic unit element composing an online-streamer image picture.

Each pixel has a specific location and an allocated color value. The color value may be a value corresponding to a color when a pixel is displayed, for example, an ARGB value or an RGB value.

Encrypting the color value of each pixel of the online-streamer image picture can improve a difference between the online-streamer image encryption picture and the online-streamer image picture, thereby improving security of the online-streamer image picture in a transmission process.

In some embodiments, the color value may include two types: transparency and color value. Therefore, when the color value is encrypted, the transparency and the color value may be separately encrypted. That is, when the color value includes the transparency and the color value, a specific implementation process of the performing encryption processing on the color value of each pixel based on the target obfuscation key to obtain an encrypted color value of each pixel may be as follows:

starting from an i^{th} pixel in the online-streamer image picture,

performing an exclusive OR operation on transparency of the i^{th} pixel in the online-streamer image picture and a value of a (2i−1)^{th} bit in the target obfuscation key to obtain encrypted transparency of the i^{th} pixel, where i=1;

performing an exclusive OR operation on a color value of the i^{th} pixel in the online-streamer image picture and a value of a 2i^{th} bit in the target obfuscation key to obtain an encrypted color value of the i^{th} pixel;

obtaining an encrypted color value of the i^{th} pixel based on the encrypted transparency and the encrypted color value of the i^{th} pixel;

determining whether the i^{th} pixel in the online-streamer image picture is the last pixel; and

if no, increasing i by 1, and returning to the step of performing an exclusive OR operation on transparency of the i^{th} pixel in the online-streamer image picture and a value of a (2i−1)^{th} bit in the target obfuscation key.

Specifically, the transparency is used to indicate a degree of transparency of a pixel. Greater transparency indicates a more transparent pixel. The color value is a value corresponding to a color when a pixel is displayed, such as an RGB value.

In a manner of encrypting the transparency and the color value, encryption of the online-streamer image picture can be implemented at a finer granularity. This further improves a difference between the online-streamer image encryption picture and the online-streamer image picture, and further improves security of the online-streamer image picture in a transmission process.

In some embodiments, the color value may include transparency, a first color value, a second color value, and a third color value. Therefore, when the color value is encrypted, the transparency, the first color value, the second color value, and the third color value may be separately encrypted. That is, when the color value includes the transparency, the first color value, the second color value, and the third color value, a specific implementation process of the performing encryption processing on the color value of each pixel based on the target obfuscation key to obtain an encrypted color value of each pixel may be as follows:

starting from a j^{th} pixel in the online-streamer image picture,

performing an exclusive OR operation on transparency of the j^{th} pixel in the online-streamer image picture and a value of a (4j−3)^{th} bit in the target obfuscation key to obtain encrypted transparency of the j^{th} pixel, where j=1;

performing an exclusive OR operation on a first color value of the j^{th} pixel in the online-streamer image picture and a value of a (4j−2)^{th} bit in the target obfuscation key to obtain an encrypted first color value of the j^{th} pixel;

performing an exclusive OR operation on a second color value of the j^{th} pixel in the online-streamer image picture and a value of a (4j−1)^{th} bit in the target obfuscation key to obtain an encrypted second color value of the j^{th} pixel;

performing an exclusive OR operation on a third color value of the j^{th} pixel in the online-streamer image picture and a value of a 4^{th} bit in the target obfuscation key to obtain an encrypted third color value of the j^{th} pixel;

obtaining an encrypted color value of the j^{th} pixel based on the encrypted transparency, the encrypted first color value, the encrypted second color value, and the encrypted third color value of the j^{th} pixel;

determining whether the j^{th} pixel in the online-streamer image picture is the last pixel; and

if no, increasing j by 1, and returning to the step of performing an exclusive OR operation on transparency of the j^{th} pixel in the online-streamer image picture and a value of a (4j−3)^{th} bit in the target obfuscation key.

Specifically, the transparency is used to indicate a degree of transparency of a pixel. Greater transparency indicates a more transparent pixel. The first color value, the second color value, and the third color value are values separately corresponding to red, green, and blue when a pixel is displayed, that is, the first color value, the second color value, and the third color value are respectively an R value, a G value, and a B value.

It should be noted that, there is a large quantity of pixels in the online-streamer image picture. When the color value of the pixel is encrypted, if a value of each bit of the target obfuscation key needs to be in a one-to-one correspondence with the transparency and the color value of each pixel, or the value of each bit of the target obfuscation key needs to be in a one-to-one correspondence with the transparency, the first color value, the second color value, and the third color value of each pixel, the target obfuscation key is extremely complex and huge. Consequently, a data processing amount of the server for the target obfuscation key is increased. Therefore, to reduce the data processing amount of the server, the value of each bit of the target obfuscation key can be used cyclically. That is, when the color values of the pixels have not been all encrypted, a value of the last bit of the target obfuscation key has been obtained, a value of the first bit of the target obfuscation key may be continued to be used when a next value is to be obtained. The operation is repeated in this way

Step a3: If a livestreaming interaction request is received for the first online streamer end and a second online streamer end, send the online-streamer image encryption picture and the target obfuscation key to the second online streamer end.

Specifically, the livestreaming interaction request is a request generated based on an interaction requirement during livestreaming of two online streamers, and may be a co-hosting request or a pk request. It should be noted that, there may be only one or more online streamers interacting with the first online streamer simultaneously. When there are multiple online streamers interacting with the first online streamer simultaneously, a second online streamer is any one of the online streamers interacting with the first online streamer simultaneously. The second online streamer is an online streamer interacting with the first online streamer. An online-streamer identifier may be a name of an online streamer, or may be an identity document (ID), that is, a sequence number or an account number of the online streamer. This is not limited in this application. The second online streamer end refers to a client associated with the second online streamer, that is, an online streamer end corresponding to the second online streamer.

In addition, the livestreaming interaction request may carry an online-streamer identifier of the second online streamer. Therefore, the server may determine, based on the online-streamer identifier of the second online streamer in the livestreaming interaction request, the second online streamer end corresponding to the second online streamer, and send the online-streamer image encryption picture and the target obfuscation key to the second online streamer end. Then, the second online streamer end decrypts the online-streamer image encryption picture based on the target obfuscation key to obtain the online-streamer image picture of the first online streamer, and further renders a first online streamer image on the second online streamer end based on the online-streamer image picture of the first online streamer.

An online-streamer image picture before encryption is the online-streamer image picture of the first online streamer. After the online-streamer image picture is encrypted, the online-streamer image encryption picture is obtained. The online-streamer image encryption picture is completely different from the online-streamer image picture before encryption. After the online-streamer image encryption picture is decrypted, a decrypted online-streamer image picture is obtained. The decrypted online-streamer image picture and the online-streamer image picture before encryption are the same, and both are the picture online-streamer image of the first online streamer.

It should be noted that, to ensure transmission security of the online-streamer image picture, the server sends the online-streamer image encryption picture and the target obfuscation key to the second online streamer end in two times. First, when receiving the livestreaming interaction request for the first online streamer end and the second online streamer end, the server sends, based on the online-streamer identifier of the second online streamer in the livestreaming interaction request, the online-streamer image encryption picture to the second online streamer end associated with the second online streamer. Then, after receiving the online-streamer image encryption picture, the second online streamer end requests the target obfuscation key from the server. In this case, the server sends the target obfuscation key to the second online streamer end. Before sending the target obfuscation key to the second online streamer end, the server further needs to record file usage information of the second online streamer end. The file usage information includes at least one of a user identifier, a usage scenario, a usage range, a usage file identifier, and a usage time that are corresponding to the second online streamer end. In this way, based on usage traceability of the target obfuscation key, a leakage path can be traced, so as to provide clues and data support for accountability and preservation after an unfortunate loss.

In addition, after receiving the target obfuscation key, the second online streamer end may directly generate a key picture based on the target obfuscation key, and then obtain the online-streamer image picture of the first online streamer based on the key picture and the online-streamer image encryption picture. Alternatively, the online-streamer image encryption picture may be decrypted directly based on the target obfuscation key, to obtain the online-streamer image picture of the first online streamer.

It should be noted that, after obtaining the online-streamer image picture of the first online streamer, the second online streamer end needs to render the first online streamer image on the second online streamer end based on the online-streamer image picture, and generate, with reference to a second online streamer image, an interaction video stream in which the first online streamer interacts with the second online streamer, and then push the interaction video stream to the server. After receiving the interaction video stream, the server determines an audience identifier corresponding to the second online streamer, that is, determines an audience of the second online streamer, and then sends the interaction video stream to an audience client on which the audience of the second online streamer is located. This helps the audience client display an interaction picture of the first online streamer and the second online streamer based on the interaction video stream.

The following embodiment describes an online-streamer image picture transmission method, applied to a second online streamer end, including steps b1 to b3:

Step b1: Receive an online-streamer image encryption picture and a target obfuscation key sent by a server, where the online-streamer image encryption picture is obtained by the server by performing encryption processing on an online-streamer image picture based on the target obfuscation key and picture information of the online-streamer image picture sent by a first online streamer end.

Specifically, a second online streamer refers to an online streamer interacting with a first online streamer. The first online streamer end refers to a client on which the first online streamer is located. The second online streamer end refers to a client associated with the second online streamer, that is, an online streamer end corresponding to the second online streamer.

In actual application, after receiving the online-streamer image picture sent by the first online streamer end, the server obtains the target obfuscation key, and then performs encryption processing on the online-streamer image picture based on the target obfuscation key and the picture information of the online-streamer image picture, to obtain the online-streamer image encryption picture. Then, after receiving a livestreaming interaction request for the first online streamer end and the second online streamer end, the server determines, based on an online-streamer identifier of the second online streamer in the livestreaming interaction request, the second online streamer end corresponding to the second online streamer, and sends the online-streamer image encryption picture and the target obfuscation key to the second online streamer end. That is, the second online streamer end receives the online-streamer image encryption picture and the target obfuscation key sent by the server.

Step b2: Generate, based on the target obfuscation key, a key picture corresponding to the online-streamer image encryption picture.

Specifically, the key picture refers to a key picture obtained by using a value of each bit of the target obfuscation key as a color value of a pixel.

In some embodiments, the value of each bit of the target obfuscation key is used as the color value of the pixel, and the key picture is generated based on a pixel corresponding to the obtained color value.

In some embodiments, the color value includes transparency and a color value. In this case, values of every two adjacent bits in the target obfuscation key may be separately used as transparency and a color value of a pixel. The key picture is generated based on a pixel corresponding to obtained transparency and an obtained color value.

In some embodiments, the color value includes transparency, a first color value, a second color value, and a third color value. In this case, values of every four adjacent bits in the target obfuscation key may be separately used as transparency, a first color value, a second color value, and a third color value of a pixel. The key picture is generated based on a pixel corresponding to obtained transparency, an obtained first color value, an obtained second color value, and an obtained third color value.

Step b3: Perform decryption processing on the online-streamer image encryption picture based on the key picture to obtain the online-streamer image picture.

Based on the target obfuscation key, in addition to generating the key picture, the online-streamer image picture is further obtained based on the key picture and the online-streamer image encryption picture

In actual application, after generating the key picture, the second online streamer end may restore the online-streamer image encryption picture based on the key picture, that is, perform decryption processing, to obtain the online-streamer image picture of the first online streamer.

The following embodiment describes an online-streamer image model file transmission method, applied to a server, including steps c1 to c4:

Step c1: Receive an image model file of a first online streamer sent by a first online streamer end.

Specifically, the image model file refers to resources such as a picture and a model used to form an avatar of the first online streamer.

In actual application, when an online streamer selects, on an upload screen by using a client on which the online streamer is located, an online-streamer image picture that needs to be uploaded by the online streamer and that is used to construct an image model file of an online-streamer image, after “OK” or any button that indicates confirmation of uploading is clicked, the client sends the image model file of the online streamer to the server. That is, the first online streamer end sends the image model file of the first online streamer to the server. That is, the server receives the image model file of the first online streamer sent by the first online streamer end.

It should be noted that, the image model file may include an image picture and an image model. The image model may be two-dimensional or may be three-dimensional. This is not limited in this application.

Step c2: Obtain a target key, and perform encryption processing on the image model file based on the target key to obtain an image model encryption file.

Specifically, the key is a parameter entered in an algorithm for converting a plaintext into a ciphertext or converting a ciphertext into a plaintext. The target key is a key for the image model file. The image model encryption file refers to an encrypted image model file. Encryption processing refers to a process of changing original information data by using a special algorithm.

In addition, to increase a transmission speed of the image model file in a transmission process and reduce transmission duration, a size of the image model file may be compressed, that is, before encryption processing is performed on the image model file based on the target key to obtain the image model encryption file, the method further includes:

performing scaling processing on picture data in the image model file to obtain an updated image model file; and

the performing encryption processing on the image model file based on the target key to obtain the image model encryption file correspondingly includes:

performing encryption processing on the updated image model file based on the target key to obtain the image model encryption file.

Specifically, scaling processing refers to a process of reducing a data amount of the picture data by changing some formats of the picture data.

In actual application, scaling processing may be performed on the picture data in the image model file according to a preset scaling rule, to reduce a package size of the image model file and obtain the updated image model file. Then, encryption processing is performed on the updated image model file based on the target key to obtain the image model encryption file.

In one or more embodiments of this application, to increase a speed of loading the image model file by a second client, scaling processing may be performed on the picture data based on one or more common application scenarios, so as to send image model files obtained after different scaling processing based on different application scenarios of the second client. That is, a specific implementation process of the performing scaling processing on picture data in the image model file to obtain an updated image model file may be as follows:

obtaining a preset scaling specification table, where the preset scaling specification table includes at least one scaling specification; and

performing scaling processing on the picture data in the image model file by using the scaling specification, to obtain the updated image model file after the picture data is scaled.

Specifically, the scaling specification refers to a standard for scaling picture data, so that picture data obtained after scaling processing meets the scaling specification. The preset scaling specification table refers to a set of scaling specifications.

To further improve transmission security of the image model file and increase deciphering difficulty of the image model encryption file, encryption processing may be performed twice on the image model file. First encryption processing is performed on the image model file based on a preset obfuscation encryption algorithm, and second encryption processing is performed on an image model file based on a preset symmetric encryption algorithm. That is, when the target key includes an obfuscation key and a symmetric key, a specific implementation process of performing encryption processing on the image model file based on the target key to obtain the image model encryption file may be as follows:

obtaining the preset obfuscation encryption algorithm and the obfuscation key, and performing first encryption processing on the image model file based on the preset obfuscation encryption algorithm and the obfuscation key to obtain an intermediate image model file; and

obtaining the preset symmetric encryption algorithm and the symmetric key, and performing second encryption processing on the intermediate image model file based on the preset symmetric encryption algorithm and the symmetric key to obtain the image model encryption file.

Specifically, obfuscation is an encryption operation that obfuscates a relationship between a key and a ciphertext (the image model file) as much as possible. The obfuscation key is a key corresponding to obfuscation, and may be a string, such as a combination of at least one of a number, a letter, and a symbol, or may be in a form of a matrix, an array, or the like. The preset obfuscation encryption algorithm is an obfuscation encryption algorithm set in advance, and may be an exclusive OR obfuscation encryption algorithm or an AND obfuscation encryption algorithm, which is not limited in this application. A symmetric encryption algorithm refers to an encryption method using a single-key cryptosystem, where a same key may be used for both information encryption and information decryption, which is alternatively referred to as single key encryption. The preset symmetric encryption algorithm refers to a symmetric encryption algorithm set in advance, and may be a data encryption standard (DES) algorithm or an advanced encryption standard (AES) algorithm, which is not limited in this application. The symmetric key refers to a key corresponding to the preset symmetric encryption algorithm.

In actual application, the target key may include the obfuscation key and the symmetric key. The preset obfuscation encryption algorithm and an obfuscation key corresponding to the image model file may be first obtained, and then the image picture in the image model file is read. Then, based on the obfuscation key, encryption processing is performed on a color value of each pixel in the image picture by using the preset obfuscation encryption algorithm, to generate the intermediate image model file after the image picture is encrypted. Then, the preset symmetric encryption algorithm and a symmetric key corresponding to the image model file are obtained. Based on the symmetric key, the intermediate image model file is encrypted by using the preset symmetric encryption algorithm to obtain the image model encryption file.

The server may include a management area, a database, and a processing area. After receiving an online-streamer image model file of the first online streamer, the first online streamer end uploads the online-streamer image model file to the server. The server stores the online-streamer image model file and determines image information by using the database. The image information is information determined by the database based on the online-streamer image model file, and includes a unique identifier of the online-streamer image model file, that is, an image unique identifier. The database transmits the image information to the management area of the server. The management area returns the image information to the first online streamer end, and the management area pushes the image information to a task processing queue for processing by the processing area. The processing area requests the online-streamer image model file from the database based on the image information, and then the database returns the image information to the processing area. The processing area performs scaling, encryption, and other processing on the online-streamer image model file to obtain the online-streamer image model encryption file.

The server may alternatively include an execution area (a general name of the management area and the processing area) and a database: After receiving an online-streamer image model file of the first online streamer, the first online streamer end packages the online-streamer image model file, and uploads the online-streamer image model file to the server. The server stores the online-streamer image model file in the database and determines a storage link. The storage link is a storage address of the online-streamer image model file in the database. The database sends the storage link to the first online streamer end, and then the first online streamer end stores the storage link, and sends the storage link to the execution area. The execution area stores the storage link, and determines an image unique identifier, that is, determines the image unique identifier based on the storage link. Further, the execution area obtains processing configuration, then pushes the image unique identifier to an asynchronous processing queue. The asynchronous processing queue performs compression processing on the image unique identifier based on the processing configuration, and image information is obtained after processing is completed, where the image information includes the image unique identifier. The execution area returns the image information to the first online streamer end. An online-streamer image model file encryption method may be performed.

Specifically, the execution area in the server receives a push task, and then obtains online-streamer image information, so as to determine whether an online-streamer image model file corresponding to the online-streamer image information is encrypted. If the online-streamer image model file is encrypted, a process is exited. If the online-streamer image model file is not encrypted, the online-streamer image model file is requested from the database based on the online-streamer image information. If a request fails, the online-streamer image model file is requested again. If the request succeeds, the database returns the online-streamer image model file. The execution area decompresses the online-streamer image model file by using a decompression algorithm, and invokes an ffmpeg command to perform scaling processing on picture data of the online-streamer image model file based on the preset scaling specification table. An obfuscation key is generated, and first encryption processing is performed on the picture data of the online-streamer image model file by using the preset obfuscation encryption algorithm, to obtain an intermediate online-streamer image model file and record the obfuscation key. The symmetric key is obtained, and second encryption processing, that is, symmetric encryption, is performed on the intermediate online-streamer image model file. The symmetric key may be a 256-bit key, and each online-streamer image model encryption file corresponds to one independent symmetric key. Compression processing is performed on the intermediate online-streamer image model file obtained after second encryption processing, to obtain the online-streamer image model encryption file. The online-streamer image model encryption file is sent to the database, and the database saves the encrypted online-streamer image file. After the database returns save success information, the execution area determines that single task processing is completed. After all task processing is completed, a task processing status is updated to complete push tasks.

Step c3: If an interaction request for the first online streamer and a second online streamer is received, send the online-streamer image model encryption file to a second online streamer end based on an online-streamer identifier that is of the second online streamer and that is carried in the interaction request.

In one or more embodiments of this specification, after receiving the interaction request for the first online streamer and the second online streamer, the server may send, based on the online-streamer identifier that is of the second online streamer and that is carried in the interaction request, a download link of the online-streamer image model encryption file to the second online streamer end. Then, the second online streamer end downloads the corresponding online-streamer image model encryption file from the database of the server based on the download link.

Step c4: When a decryption request sent by the second online streamer end is received, send the target key to the second online streamer end, where the target key is used by the second online streamer end to decrypt the online-streamer image model encryption file to obtain the online-streamer image model file.

In actual application, after receiving the encrypted online-streamer image file, the second online streamer end needs to request a target obfuscation key from the server. In this case, the second online streamer end generates the decryption request based on the online-streamer image model encryption file, and then sends the decryption request to the server. That is, the server receives the decryption request sent by the second online streamer end. Further, the second online streamer end sends, based on an identifier that is of the online-streamer image model encryption file and that is carried in the decryption request, a target key corresponding to the online-streamer image model encryption file to the second online streamer end. Then, the second online streamer end decrypts the online-streamer image model encryption file based on the target key to obtain the online-streamer image model file of the first online streamer, and further renders an image of the first online streamer on the second online streamer end based on the online-streamer image model file of the first online streamer.

After the first encryption processing is performed on the picture data, encrypted picture data is obtained. The encrypted picture data is completely different from the picture data before encryption. After the encrypted picture data is decrypted, decrypted picture data is obtained. The decrypted picture data and the picture data before encryption are the same, and both are original picture data in the online-streamer image model file.

To improve security of the online-streamer image model file, when receiving the decryption request, the server needs to verify the decryption request, so as to determine properness of using the target key by a client sending the decryption request. If verification succeeds, the server returns the target key, that is, sends the target key to the second online streamer end. A specific implementation process may be as follows:

checking the decryption request sent by the second online streamer end, and determining whether the decryption request meets a preset decryption rule;

if yes, sending the target key to the second online streamer end; or

if no, skipping responding to the decryption request.

Specifically, the preset decryption rule is a rule for determining whether it is reasonable for the client to request the target key, that is, a rule for determining whether the decryption request is reasonable, for example, determining whether the client sending the decryption request is the second online streamer end on which the second online streamer is located.

In some embodiments, to prevent the target key from being intercepted in a process of being sent from the server to the second online streamer end, or that the server mistakenly sends the target key to another client, which causes leakage of the target key and further causes leakage of the online-streamer image model file, the decryption request sent by the second online streamer end carries a public key of the second online streamer end, so that the server encrypts the target key based on the public key of the second online streamer end, so as to prevent leakage of the target key. That is, when the decryption request carries the public key of the second online streamer end, a specific implementation process of sending the target key to the second online streamer end may be as follows:

performing third encryption processing on the target key based on the public key of the second online streamer end to obtain an encrypted target key; and

sending the encrypted target key to the second online streamer end.

Specifically, the public key of the second online streamer end refers to a key that is provided by the second online streamer end and that is used to encrypt the target key.

In some embodiments, to prevent the target key from being intercepted in a process of being sent from the server to the second online streamer end, or that the server mistakenly sends the target key to another client, which causes leakage of the target key and further causes leakage of the online-streamer image model file, when the decryption request carries the public key of the second online streamer end, a specific implementation process of sending the target key to the second online streamer end may further be as follows:

generating a server private key and a server public key, where the server private key and the server public key are a pair of keys;

generating a first key based on the public key of the second online streamer end and the server private key, and performing third encryption processing on the target key based on the first key to obtain an encrypted target key; and

sending the encrypted target key and the server public key to the second online streamer end, where the server public key is used by the second online streamer end to generate a second key with reference to a private key of the second online streamer end, and decrypting the encrypted target key based on the second key, where the private key of the second online streamer end and the public key of the second online streamer end are a pair of keys.

In actual application, the second online streamer end generates a pair of public key and private key, that is, the private key of the second online streamer end and the public key of the second online streamer end.

In addition, to ensure transmission security of the image picture or to trace a source of a leakage path in the later period, before the server sends the target key to the second online streamer end, the server further needs to record file usage information of the second online streamer end. That is, before sending the target key to the second online streamer end, the method further includes:

when the decryption request complies with the preset decryption rule, extracting and recording file usage information that is of the second online streamer end and carried in the decryption request, where the file usage information includes at least one of a user identifier, a usage scenario, a usage range, a usage file identifier, and a usage time that are corresponding to the second online streamer end.

Specifically, the user identifier is a user corresponding to the second online streamer end, that is, a user identifier of the second online streamer. The usage scenario refers to a display resolution of a computer device corresponding to the second online streamer end, for example, a screen resolution of a mobile phone or a display resolution of a computer. The use range refers to a purpose of using the target key and the online-streamer image model encryption file by the second online streamer end. The use file identifier refers to identifiers corresponding to the target key and the online-streamer image model encryption file used by the second online streamer end. The use time refers to time at which the second online streamer end uses the target key and the online-streamer image model encryption file, and the use time may be represented by using time at which the second online streamer end sends the encryption request.

During interaction between the first online streamer and the second online streamer, the second online streamer end further needs to render a first online streamer dynamic image on the second online streamer end based on the online-streamer image model file, generates an interaction video stream of interaction between the first online streamer and the second online streamer, and sends the interaction video stream to the server. Then, the server sends the interaction video stream to a client on which an audience of the second online streamer is located. That is, after the target key is sent to the second online streamer end, the method further includes:

receiving the interaction video stream sent by the second online streamer end, where the interaction video stream is generated by the second online streamer end based on the online-streamer image model file;

determining an audience identifier corresponding to the second online streamer; and

sending the interaction video stream to an audience client corresponding to the audience identifier, where the interaction video stream is used by the audience client to display an interaction picture of the first online streamer and the second online streamer.

Specifically, the interaction video stream is a video stream generated based on interaction between the first online streamer and the second online streamer, and is used to display interaction content of the first online streamer and the second online streamer. The audience identifier is an identifier corresponding to an audience of the second online streamer. The audience client refers to a client on which the audience of the second online streamer is located.

In actual application, after the second online streamer end decrypts the online-streamer image model encryption file to obtain the online-streamer image model file, the second online streamer end renders the first online streamer dynamic image on the second online streamer end based on the online-streamer image model file, generates, with reference to a second online streamer image, the interaction video stream of interaction between the first online streamer and the second online streamer, and then pushes the interaction video stream to the server. After receiving the interaction video stream, the server determines the audience identifier corresponding to the second online streamer, that is, determines the audience of the second online streamer, and then sends the interaction video stream to the audience client on which the audience of the second online streamer is located. This helps the audience client display the interaction picture of the first online streamer and the second online streamer based on the interaction video stream.

The following embodiment describes an online-streamer image model file transmission method, applied to a second online streamer end, including d1 to d3:

Step d1: Receive an online-streamer image model encryption file sent by a server, where the online-streamer image model encryption file is obtained by the server by performing encryption processing on an online-streamer image model file of a first online streamer based on a target key.

Specifically, the online-streamer image model file refers to resources such as a picture and a model used to form an avatar of the first online streamer. The key is a parameter entered in an algorithm for converting a plaintext into a ciphertext or converting a ciphertext into a plaintext. The target key is a key for the online-streamer image model file. The online-streamer image model encryption file refers to an image model file. Encryption processing refers to a process of changing original information data by using a special algorithm.

In actual application, after receiving the online-streamer image model file of the first online streamer sent by a first online streamer end, the server obtains the target key, and then performs encryption processing on the online-streamer image model file based on the target key to obtain the online-streamer image model encryption file. After the server receives an interaction request for the first online streamer and a second online streamer, the server determines, based on an online-streamer identifier of the second online streamer in the interaction request, a second online streamer end corresponding to the second online streamer and an audience client corresponding to an audience of the second online streamer, that is, determines the second online streamer end, and sends the online-streamer image model encryption file to the second online streamer end. That is, the second online streamer end receives the online-streamer image model encryption file sent by the server.

It should be noted that, to avoid repeatedly receiving the online-streamer image model encryption file, before receiving the online-streamer image model encryption file sent by the server, it is further needed to check whether the online-streamer image model encryption file corresponding to the first online streamer is locally stored. If the online-streamer image model encryption file is not locally stored, the online-streamer image model encryption file is requested from the server, and the server sends the online-streamer image model encryption file. That is, before the online-streamer image model encryption file sent by the server is received, the method further includes:

querying whether the online-streamer image model encryption file is stored locally; and

if no, generating a request for obtaining the online-streamer image model encryption file, and sending the request for obtaining the online-streamer image model encryption file to the server.

If it is queried that the online-streamer image model encryption file is locally stored, the second online streamer end does not need to obtain the online-streamer image model encryption file from the server. In this case, the second online streamer end may generate a decryption request based on the online-streamer image model encryption file, and send the decryption request to the server. That is, if yes, the decryption request is generated based on the online-streamer image model encryption file, and the decryption request is sent to the server.

Step d2: Generate the decryption request based on the online-streamer image model encryption file, and send the decryption request to the server.

In actual application, after receiving the online-streamer image model encryption file, the second online streamer end extracts an identifier of the online-streamer image model encryption file, such as a name and an identifier number, to generate a decryption request carrying the identifier of the online-streamer image model encryption file, and then sends the decryption request to the server for requesting, from the server, a target key corresponding to the online-streamer image model encryption file.

Step d3: Decrypt the online-streamer image model encryption file based on the target key sent by the server based on the decryption request to obtain the online-streamer image model file.

In actual application, after receiving the decryption request, the server obtains a target key corresponding to the online-streamer image model encryption file based on the identifier that is of the online-streamer image model encryption file and that is carried in the decryption request, and further sends the target key to the second online streamer end. Then, the second online streamer end decrypts the online-streamer image model encryption file by using the target key, to obtain the online-streamer image model file of the first online streamer.

It should be noted that, after obtaining the online-streamer image model file of the first online streamer, the second online streamer end needs to render a first online streamer image on the second online streamer end based on the online-streamer image model file, generates an interaction video stream, and sends the interaction video stream to the server. That is, after the online-streamer image model encryption file is decrypted based on the target key sent by the server based on the decryption request to obtain the online-streamer image model file, the method further includes:

rendering the first online streamer image based on the online-streamer image model file; and

generating an interaction video stream of the first online streamer and the second online streamer based on the first online streamer image and a second online streamer image, where the interaction video stream is used to display an interaction picture of the first online streamer and the second online streamer.

Specifically, the interaction video stream is a video stream generated based on interaction between the first online streamer and the second online streamer, and is used to display interaction content of the first online streamer and the second online streamer.

After the generating an interaction video stream, it is further needed to send the interaction video stream to the server. That is, after the generating an interaction video stream of the first online streamer and the second online streamer based on the first online streamer image and a second online streamer image, the method further includes:

sending the interaction video stream to the server, where the interaction video stream is used by the server to forward to the audience client corresponding to the second online streamer.

After receiving the interaction video stream, the server determines an audience identifier corresponding to the second online streamer, that is, determines the audience of the second online streamer, and then sends the interaction video stream to the audience client on which the audience of the second online streamer is located. This helps the audience client display the interaction picture of the first online streamer and the second online streamer based on the interaction video stream.

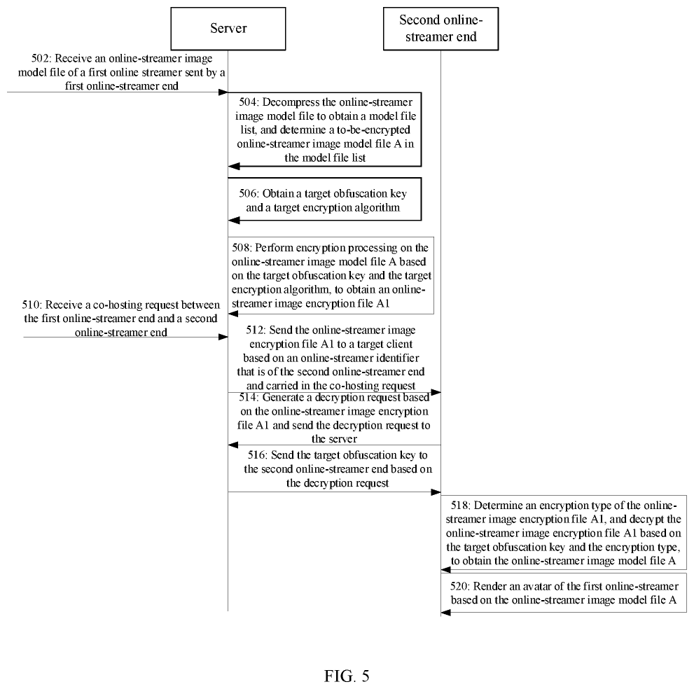

With reference to FIG. 5, for example, an online-streamer image model file transmission method provided in this application is applied to co-hosting during livestreaming, and the following further describes the online-streamer image model file transmission method. FIG. 5 is a processing flowchart of an online-streamer image model file transmission method applied to co-hosting during livestreaming according to an embodiment of this application. The method specifically includes the following steps:

Step 502: The server receives an online-streamer image model file of a first online streamer sent by a first online streamer end.

Step 504: The server decompresses the online-streamer image model file to obtain a model file list, and determines a to-be-encrypted online-streamer image model file A in the model file list.

Step 506: The server obtains a target obfuscation key and a target encryption algorithm.

Step 508: The server performs encryption processing on the online-streamer image model file A based on the target obfuscation key and the target encryption algorithm, to obtain an encrypted online-streamer image file A1.

Step 510: The server receives a co-hosting request between the first online streamer end and a second online streamer end.

Step 512: The server sends the encrypted online-streamer image file A1 to the second online streamer end based on an online-streamer identifier that is of the second online streamer end and that is carried in the co-hosting request.

Step 514: The second online streamer end generates a decryption request based on the encrypted online-streamer image file A1 and sends the decryption request to the server.

Step 516: The server sends the target obfuscation key to the second online streamer end based on the decryption request.

Step 518: The second online streamer end determines an encryption type of the encrypted online-streamer image file A1, and decrypts the encrypted online-streamer image file A1 based on the target obfuscation key and the encryption type, to obtain the online-streamer image model file A.

Step 520: The second online streamer end renders an avatar of the first online streamer based on the online-streamer image model file A.

This application provides the online-streamer image model file transmission method in co-hosting during livestreaming, including: receiving an online-streamer image model file sent by a first online streamer end, and obtaining a target obfuscation key and a target encryption type; determining a to-be-encrypted byte in the online-streamer image model file based on the target encryption type, and encrypting the to-be-encrypted byte based on the target obfuscation key to obtain an encrypted online-streamer image file; and receiving an interaction request between the first online streamer end and a second online streamer end, and sending the encrypted online-streamer image file to the second online streamer end based on the interaction request. The online-streamer image model file is encrypted based on the target obfuscation key and the target encryption type. This ensures that the online-streamer image model file is not easily obtained, effectively reduces a leakage risk of the online-streamer image model file, and improves transmission security of the online-streamer image model file. In addition, the method provided in this application is simple to apply, and reduces costs of transforming each client.

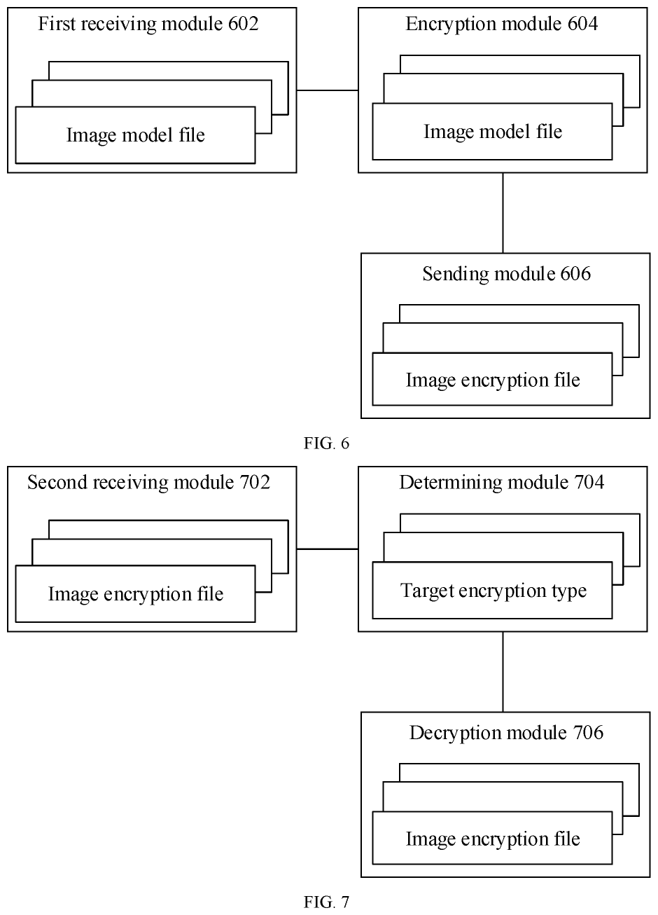

Corresponding to the foregoing method embodiments, this application further provides an embodiment of an online-streamer image model file transmission apparatus in co-hosting during livestreaming, which is applied to a server. FIG. 6 is a schematic diagram of a structure of an online-streamer image model file transmission apparatus according to an embodiment of this application. As shown in FIG. 6, the apparatus includes:

a first receiving module 602, configured to receive an online-streamer image model file sent by a first online streamer end, and obtain a target obfuscation key and a target encryption type;

an encryption module 604, configured to determine a to-be-encrypted byte in the online-streamer image model file based on the target encryption type, and encrypt the to-be-encrypted byte based on the target obfuscation key to obtain an encrypted online-streamer image file; and

a sending module 606, configured to receive an interaction request between the first online streamer end and a second online streamer end, and send the encrypted online-streamer image file to the second online streamer end based on the interaction request.

In some embodiments, the encryption module 604 is further configured to:

if the target encryption type is a prefix encryption type, determine ciphertext length information based on file attribute information of the online-streamer image model file;

determine the to-be-encrypted byte and a plaintext byte in the online-streamer image model file based on the ciphertext length information;

encrypt the to-be-encrypted byte based on the target obfuscation key to obtain an encrypted ciphertext; and

generate the encrypted online-streamer image file based on the encrypted ciphertext, the plaintext byte, and the ciphertext length information.

In some embodiments, the encryption module 604 is further configured to:

if the target encryption type is a segmented encryption type, determine at least two byte segments in the online-streamer image model file according to a preset segmentation rule, where each byte segment includes a to-be-encrypted byte and a plaintext byte;

encrypt the to-be-encrypted byte in each byte segment based on the target obfuscation key to obtain an encrypted ciphertext, and count a ciphertext quantity of encrypted ciphertexts; and

generate the encrypted online-streamer image file based on the encrypted ciphertext and the plaintext byte in each byte segment and the ciphertext quantity.

In some embodiments, the encryption module 604 is further configured to:

if the target encryption type is a full encryption type, use each byte in the online-streamer image model file as a to-be-encrypted byte, and encrypt the to-be-encrypted byte based on the target obfuscation key to obtain an encrypted ciphertext; and

generate the encrypted online-streamer image file based on the encrypted ciphertext.

In some embodiments, the first receiving module 602 is further configured to:

determine a target encryption algorithm; and

generate the target obfuscation key based on the target encryption algorithm.

In some embodiments, the first receiving module 602 is further configured to:

obtain a preset selection rule; and

determine the target encryption type based on the preset selection rule.

In some embodiments, the encryption module 604 is further configured to:

receive an online-streamer image model file encryption request, where the online-streamer image model file encryption request includes service requirement information; and

in response to the online-streamer image model file encryption request, traverse a model file list corresponding to the first online streamer end, and determine an online-streamer image model file that meets the service requirement information and that is in the model file list.

The foregoing describes a schematic solution of the online-streamer image model file transmission apparatus applied to the server in this embodiment. It should be noted that, a technical solution of the online-streamer image model file transmission apparatus is in a same concept as the foregoing technical solution of the online-streamer image model file transmission method applied to the server. For details not described in detail in the technical solution of the online-streamer image model file transmission apparatus applied to the server, references can be made to the description of the foregoing technical solution of the online-streamer image model file transmission method applied to the server.

Corresponding to the foregoing method embodiments, this application further provides an embodiment of another online-streamer image model file transmission apparatus, which is applied to a second online streamer end. FIG. 7 is a schematic diagram of a structure of another online-streamer image model file transmission apparatus according to an embodiment of this application. As shown in FIG. 7, the apparatus includes:

a second receiving module 702, configured to receive an encrypted online-streamer image file and a target obfuscation key sent by a server;

a determining module 704, configured to determine a target encryption type of the encrypted online-streamer image file based on the encrypted online-streamer image file; and

a decryption module 706, configured to decrypt the encrypted online-streamer image file based on the target obfuscation key and the target encryption type to obtain an online-streamer image model file.

In some embodiments, the decryption module 706 is further configured to:

if the target encryption type is a prefix encryption type, obtain ciphertext length information in the encrypted online-streamer image file;

determine an encrypted ciphertext and a plaintext byte in the encrypted online-streamer image file based on the ciphertext length information, and decrypt the encrypted ciphertext based on the target obfuscation key to obtain a to-be-encrypted byte; and

obtain the online-streamer image model file based on the to-be-encrypted byte and the plaintext byte.

In some embodiments, the decryption module 706 is further configured to:

if the target encryption type is a segmented encryption type, obtain a ciphertext quantity in the encrypted online-streamer image file;

determine a byte segment in the encrypted online-streamer image file based on the ciphertext quantity, and decrypt an encrypted ciphertext in each byte segment based on the target obfuscation key to obtain a to-be-encrypted byte and a plaintext byte; and

obtain the online-streamer image model file based on the to-be-encrypted byte and the plaintext byte.

In some embodiments, the decryption module 706 is further configured to:

if the target encryption type is a full encryption type, decrypt an encrypted ciphertext in the encrypted online-streamer image file based on the target obfuscation key to obtain a to-be-encrypted byte; and

obtain the online-streamer image model file based on the to-be-encrypted byte.

The foregoing describes a schematic solution of the online-streamer image model file transmission apparatus applied to the second online streamer end in this embodiment. It should be noted that, a technical solution of the online-streamer image model file transmission apparatus is in a same concept as the foregoing technical solution of the online-streamer image model file transmission method applied to the second online streamer end. For details not described in detail in the technical solution of the online-streamer image model file transmission apparatus applied to the second online streamer end, references can be made to the description of the foregoing technical solution of the online-streamer image model file transmission method applied to the second online streamer end.

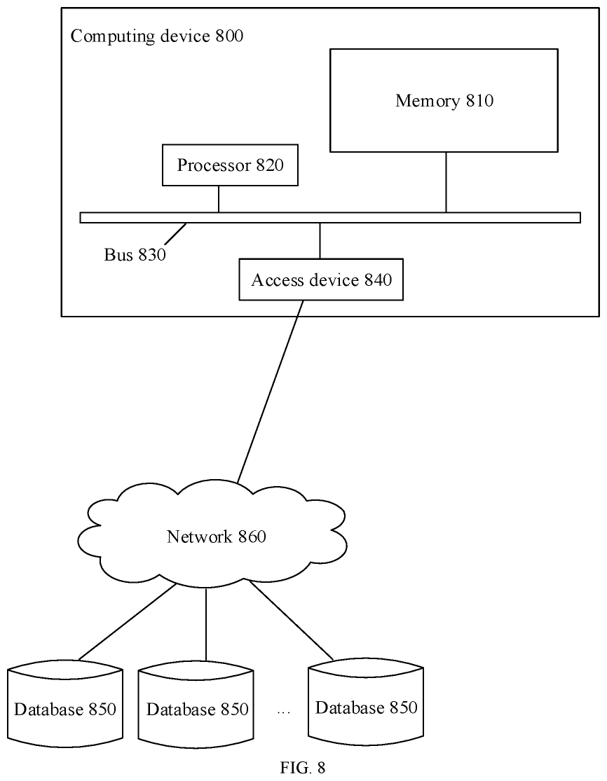

FIG. 8 is a block diagram of a structure of a computing device 800 according to an embodiment of this application. Components of the computing device 800 include but are not limited to a memory 810 and a processor 820. The processor 820 and the memory 810 are connected by using a bus 830, and a database 850 is configured to store data.

The computing device 800 further includes an access device 840, and the access device 840 enables the computing device 800 to communicate via one or more networks 860. Examples of these networks include a public switched telephone network (PSTN), a local area network (LAN), a wide area network (WAN), a private area network (PAN), or a combination of communication networks such as the Internet. The access device 840 may include one or more of any type of wired or wireless network interface (for example, a network interface card (NIC)), for example, an IEEE 802.11 wireless local area network (WLAN) wireless interface, a worldwide interoperability for microwave access (WiMAX) interface, an Ethernet interface, a universal serial bus (USB) interface, a cellular network interface, a Bluetooth interface, or a near field communication (NFC) interface.

In an embodiment of this application, the foregoing components of the computing device 800 and other components not shown in FIG. 8 may also be connected to each other, for example, by using the bus. It should be understood that the block diagram of the structure of the computing device shown in FIG. 8 is merely used as an example instead of a limitation on the scope of this application. A person skilled in the art may add or substitute other components as required.

The computing device 800 may be any type of static or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smart watch or smart glasses), another type of mobile device, or a static computing device such as a desktop computer or a PC. The computing device 800 may be alternatively a mobile or static server.

When executing computer instructions, the processor 820 implements the steps of the online-streamer image model file transmission method.

The foregoing describes a schematic solution of the computing device in this embodiment. It should be noted that, a technical solution of the computing device is in a same concept as the foregoing technical solution of the online-streamer image model file transmission method. For details not described in detail in the technical solution of the computing device, references can be made to the description of the foregoing technical solution of the online-streamer image model file transmission method.

An embodiment of this application further provides a computer-readable storage medium, where the computer-readable storage medium stores computer instructions. When the computer instructions are executed by a processor, the steps of the online-streamer image model file transmission method are implemented.

The foregoing describes a schematic solution of the computer-readable storage medium in this embodiment. It should be noted that, a technical solution of the storage medium is in a same concept as the foregoing technical solution of the online-streamer image model file transmission method. For details not described in detail in the technical solution of the storage medium, references can be made to the description of the foregoing technical solution of the online-streamer image model file transmission method.

Specific embodiments of this application are described above. Other embodiments fall within the scope of the appended claims. In some situations, the actions or steps recorded in the claims can be performed in an order different from the order in the embodiments and the desired results can still be achieved. In addition, the process depicted in the accompanying drawings does not necessarily require the shown particular order or consecutive order to achieve the desired results. In some implementations, multi-tasking and parallel processing can or may be advantageous.

The computer instructions include computer program code, and the computer program code may be in a source code form, an object code form, an executable file, an intermediate form, or the like. The computer-readable medium may include: any physical entity or apparatus capable of carrying the computer program code, a recording medium, a USB disk, a mobile hard disk drive, a magnetic disk, an optical disc, a computer memory, a read-only memory (ROM), a random access memory (RAM), an electrical carrier signal, a telecommunications signal, a software distribution medium, and the like. It should be noted that, the content contained in the computer-readable medium may be added or deleted properly according to the legislation and the patent practice in the jurisdiction. For example, in some jurisdictions, depending on the legislation and the patent practice, the computer-readable storage medium may not include the electrical carrier signal or the telecommunications signal.

It should be noted that, for ease of description, the foregoing method embodiments are described as a combination of a series of actions. However, a person skilled in the art should understand that this application is not limited to the described action sequence, because according to this application, some steps may be performed in another order or simultaneously. In addition, a person skilled in the art should also understand that the embodiments described in the specification are all preferred embodiments, and involved actions and modules are not necessarily mandatory to this application.

In the foregoing embodiments, descriptions of the embodiments have respective focuses. For a part that is not described in detail in an embodiment, references can be made to related descriptions in another embodiment.

The preferred embodiments of this application disclosed above are merely intended to help describe this application. The optional embodiments do not describe all details, and the present invention is not limited to the specific implementations. Clearly, many modifications and changes may be made based on the content of this application. The embodiments are selected and specifically described in this application to better explain the principle and actual application of this application, so that a person skilled in the art can better understand and use this application. This application is only subjected to the claims and the scope and equivalents thereof.

What is claimed is:

1. A method, applied to a server, the method comprising:
receiving an online-streamer image model file sent by a first online-streamer end, and obtaining a target obfuscation key and a target encryption type;
determining to-be-encrypted bytes in the online-streamer image model file based on the target encryption type, and encrypting the to-be-encrypted bytes based on the target obfuscation key to obtain an encrypted online-streamer image file; and
receiving an interaction request between the first online-streamer end and a second online-streamer end, and sending the encrypted online-streamer image file to the second online-streamer end based on the interaction request.

2. The method according to claim 1, wherein the determining the to-be-encrypted bytes in the online-streamer image model file based on the target encryption type, and encrypting the to-be-encrypted bytes based on the target obfuscation key to obtain the encrypted online-streamer image file comprises:
in response to determining that the target encryption type is a prefix encryption type, determining ciphertext length information based on file attribute information of the online-streamer image model file;
determining the to-be-encrypted bytes and plaintext bytes in the online-streamer image model file based on the ciphertext length information;
encrypting the to-be-encrypted bytes based on the target obfuscation key to obtain an encrypted ciphertext; and
generating the encrypted online-streamer image file based on the encrypted ciphertext, the plaintext bytes, and the ciphertext length information.

3. The method according to claim 1, wherein the determining the to-be-encrypted bytes in the online-streamer image model file based on the target encryption type, and encrypting the to-be-encrypted bytes based on the target obfuscation key to obtain the encrypted online-streamer image file comprises:
in response to determining that the target encryption type is a segmented encryption type, determining at least two byte segments in the online-streamer image model file based on a preset segmentation rule, wherein each byte segment comprises the to-be-encrypted bytes and plaintext bytes;
encrypting the to-be-encrypted bytes in each byte segment based on the target obfuscation key to obtain an encrypted ciphertext, and counting a ciphertext quantity of encrypted ciphertexts; and
generating the encrypted online-streamer image file based on the encrypted ciphertext and the plaintext bytes in each byte segment and the ciphertext quantity.

4. The method according to claim 1, wherein the determining the to-be-encrypted bytes in the online-streamer image model file based on the target encryption type, and encrypting the to-be-encrypted bytes based on the target obfuscation key to obtain the encrypted online-streamer image file comprises:
in response to determining that the target encryption type is a full encryption type, using each byte in the online-streamer image model file as the to-be-encrypted bytes, and encrypting the to-be-encrypted bytes based on the target obfuscation key to obtain an encrypted ciphertext; and
generating the encrypted online-streamer image file based on the encrypted ciphertext.

5. The method according to claim 1, wherein the obtaining the target obfuscation key comprises:
determining a target encryption algorithm; and
generating the target obfuscation key based on the target encryption algorithm.

6. The method according to claim 1, wherein the obtaining the target encryption type comprises:
obtaining a preset selection rule; and
determining the target encryption type based on the preset selection rule.

7. The method according to claim 1, further comprising: before the encrypting the to-be-encrypted bytes based on the target obfuscation key, receiving an online-streamer image model file encryption request, wherein the online-streamer image model file encryption request comprises service requirement information; and
in response to the online-streamer image model file encryption request, traversing a model file list corresponding to the first online-streamer end, and determining an online-streamer image model file, which meets the service requirement information, in the model file list.

8. A non-transient computer-readable storage medium storing one or more programs, the one or more programs comprising instructions, which when executed by one or more processors of an electronic device, cause the electronic device to implement the steps of the method according to claim 1.

9. A computing device, comprising:
one or more processors;
a memory storing one or more programs configured to be executed by the one or more processors, the one or more programs comprising instructions for implementing the steps of the method according to claim 1.

10. The computing device according to claim 9, wherein the determining the to-be-encrypted bytes in the online-streamer image model file based on the target encryption type, and encrypting the to-be-encrypted bytes based on the target obfuscation key to obtain the encrypted online-streamer image file comprises:
in response to determining that the target encryption type is a prefix encryption type, determining ciphertext length information based on file attribute information of the online-streamer image model file;
determining the to-be-encrypted bytes and plaintext bytes in the online-streamer image model file based on the ciphertext length information;
encrypting the to-be-encrypted bytes based on the target obfuscation key to obtain an encrypted ciphertext; and
generating the encrypted online-streamer image file based on the encrypted ciphertext, the plaintext bytes, and the ciphertext length information.

11. The computing device according to claim 9, wherein the determining the to-be-encrypted bytes in the online-streamer image model file based on the target encryption type, and encrypting the to-be-encrypted bytes based on the target obfuscation key to obtain the encrypted online-streamer image file comprises:
in response to determining that the target encryption type is a segmented encryption type, determining at least two byte segments in the online-streamer image model file based on a preset segmentation rule, wherein each byte segment comprises the to-be-encrypted bytes and plaintext bytes;
encrypting the to-be-encrypted bytes in each byte segment based on the target obfuscation key to obtain an encrypted ciphertext, and counting a ciphertext quantity of encrypted ciphertexts; and
generating the encrypted online-streamer image file based on the encrypted ciphertext and the plaintext bytes in each byte segment and the ciphertext quantity.

12. A method, applied to a second online-streamer end, the method comprising:
receiving an encrypted online-streamer image file and a target obfuscation key sent by a server;
determining a target encryption type of the encrypted online-streamer image file based on the encrypted online-streamer image file; and
decrypting the encrypted online-streamer image file based on the target obfuscation key and the target encryption type to obtain an online-streamer image model file.

13. The method according to claim 12, wherein the decrypting the encrypted online-streamer image file based on the target obfuscation key and the target encryption type to obtain the online-streamer image model file comprises:
in response to determining that the target encryption type is a prefix encryption type, obtaining ciphertext length information in the encrypted online-streamer image file;
determining an encrypted ciphertext and plaintext bytes of the encrypted online-streamer image file based on the ciphertext length information, and decrypting the encrypted ciphertext based on the target obfuscation key to obtain to-be-encrypted bytes; and
obtaining the online-streamer image model file based on the to-be-encrypted bytes and the plaintext bytes.

14. The method according to claim 12, wherein the decrypting the encrypted online-streamer image file based on the target obfuscation key and the target encryption type to obtain the online-streamer image model file comprises:
in response to determining that the target encryption type is a segmented encryption type, obtaining a ciphertext quantity in the encrypted online-streamer image file;
determining a byte segment in the encrypted online-streamer image file based on the ciphertext quantity, and decrypting an encrypted ciphertext in each byte segment based on the target obfuscation key to obtain to-be-encrypted bytes and plaintext bytes; and
obtaining the online-streamer image model file based on the to-be-encrypted bytes and the plaintext bytes.

15. The method according to claim 12, wherein the decrypting the encrypted online-streamer image file based on the target obfuscation key and the target encryption type to obtain the online-streamer image model file comprises:
in response to determining that the target encryption type is a full encryption type, decrypting an encrypted ciphertext in the encrypted online-streamer image file based on the target obfuscation key to obtain to-be-encrypted bytes; and
obtaining the online-streamer image model file based on the to-be-encrypted bytes.

16. A non-transient computer-readable storage medium storing one or more programs, the one or more programs comprising instructions, which when executed by one or more processors of an electronic device, cause the electronic device to implement the steps of the method according to claim 12.

17. A computing device, applied to a second online-streamer end, the computing device comprising:
one or more processors, and a memory storing one or more programs configured to be executed by the one or more processors, the one or more programs comprising instructions for:
receiving an encrypted online-streamer image file and a target obfuscation key sent by a server;
determining a target encryption type of the encrypted online-streamer image file based on the encrypted online-streamer image file; and
decrypting the encrypted online-streamer image file based on the target obfuscation key and the target encryption type to obtain an online-streamer image model file.

18. The computing device according to claim 17, wherein the decrypting the encrypted online-streamer image file based on the target obfuscation key and the target encryption type to obtain the online-streamer image model file comprises:
in response to determining that the target encryption type is a prefix encryption type, obtaining ciphertext length information in the encrypted online-streamer image file;
determining an encrypted ciphertext and plaintext bytes of the encrypted online-streamer image file based on the ciphertext length information, and decrypting the encrypted ciphertext based on the target obfuscation key to obtain to-be-encrypted bytes; and
obtaining the online-streamer image model file based on the to-be-encrypted bytes and the plaintext bytes.

19. The computing device according to claim 17, wherein the decrypting the encrypted online-streamer image file based on the target obfuscation key and the target encryption type to obtain the online-streamer image model file comprises:
in response to determining that the target encryption type is a segmented encryption type, obtaining a ciphertext quantity in the encrypted online-streamer image file;
determining a byte segment in the encrypted online-streamer image file based on the ciphertext quantity, and decrypting an encrypted ciphertext in each byte segment based on the target obfuscation key to obtain to-be-encrypted bytes and plaintext bytes; and
obtaining the online-streamer image model file based on the to-be-encrypted bytes and the plaintext bytes.

20. The computing device according to claim 17, wherein the decrypting the encrypted online-streamer image file based on the target obfuscation key and the target encryption type to obtain the online-streamer image model file comprises:
in response to determining that the target encryption type is a full encryption type, decrypting an encrypted ciphertext in the encrypted online-streamer image file based on the target obfuscation key to obtain to-be-encrypted bytes; and
obtaining the online-streamer image model file based on the to-be-encrypted bytes.
